(19) United States
(12) Patent Application Publication
(10) Pub. No.: US 2015/0148161 A1
(43) Pub. Date: May 28, 2015

(54) NON-CIRCULAR ROTARY COMPONENT

(71) Applicant: LITENS AUTOMOTIVE PARTNERSHIP, Woodbridge (CA)

(72) Inventors: Witold Gajewski, Richmond Hill (CA); Alin Cotrau, Brampton (CA)

(21) Appl. No.: 14/396,993

(22) PCT Filed: Apr. 25, 2013
(86) PCT No.: PCT/CA2013/000407

§ 371 Date: Oct. 24, 2014

Related U.S. Application Data
(60) Provisional application No. 61/638,471, filed on Apr. 25, 2012.

(51) Int. Cl. F16H 55/08; F01L 1/02; F16H 55/30

(52) U.S. Cl. CPC F16H 55/084; F16H 55/30; F01L 1/02
USPC 474/141

(57) ABSTRACT

A rotary component is provided, including a body that has a non-circular periphery and a plurality of teeth positioned about the periphery of the body. The non-circular periphery of the body causes variation in the tension generated in an endless drive member engaged with the rotary component during rotation of the rotary component about an axis. A valley separates each tooth from each adjacent tooth. At least one of the width of each valley and the tooth pitch is generally related to the amount of tension generated in the endless drive member during rotation of the rotary component about the axis at a time when the valley receives a belt tooth. In a preferred embodiment, both the valley width and the tooth pitch are generally related to the amount of tension generated in the endless drive member during rotation of the rotary component about the axis at a time when the valley receives a belt tooth.

### FIELD

The present invention relates to a non-circular rotary component in particular but not exclusively for a synchronous drive apparatus, and to a method of constructing such a component. The component may comprise a non-circular sprocket component which may be used for the elimination or reduction of mechanical vibrations, in particular but not exclusively in internal combustion engines.

### BACKGROUND OF INVENTION

Synchronous drive systems, such as timing belt based systems, are widely used in motor vehicles, as well as in industrial applications. In motor vehicles, for example, timing belts or chains are used to drive the camshafts that open and close the engine intake and exhaust valves. Also other devices such as water pumps, fuel pumps etc. can be driven by the same belt or chain.

Internal combustion engines produce many types of mechanical vibrations during their operation, and these vibrations are usually transmitted through the timing belt or chain in the synchronous drive system. A particularly intense source of mechanical vibrations is given by the intake and exhaust valves and the camshafts that open and close those intake and exhaust valves. Opening and closing the intake and exhaust valves leads to a type of vibration known as torsional vibration. When the frequency of these vibrations is close to the natural frequency of the drive, system resonance occurs. In resonance the torsional vibrations and the span tension fluctuations are at their maximum.

Torsional vibrations cause fluctuations in belt or chain tension, which can lead to increased wear and reduced belt or chain life. Torsional vibrations may also cause timing errors, and result in undesirable amounts of noise.

It is known to provide non-circular sprocket components in such drive systems to attempt to reduce or eliminate vibration. However, at least some such sprockets are designed with a constant tooth pitch, and a constant valley width.

### SUMMARY

A non-circular rotary component is provided, including a body that has a non-circular periphery and a plurality of teeth positioned about the periphery of the body. The non-circular periphery of the body causes variation in the tension generated in an endless drive member engaged with the rotary component during rotation of the rotary component about an axis. A valley separates each tooth from each adjacent tooth. At least one of the width of each valley and the tooth pitch is generally related to the amount of tension generated in the endless drive member during rotation of the rotary component about the axis at a time when the valley receives a belt tooth. In a preferred embodiment, both the valley width and the tooth pitch are generally related to the amount of tension generated in the endless drive member during rotation of the rotary component about the axis at a time when the valley receives a belt tooth.

A method for generating a profile for a non-round rotary component is also provided for, as described herein and shown in FIG. 6.

### DESCRIPTION OF THE DRAWINGS

Embodiments will now be described by way of example with reference to the accompanying drawings in which:

FIG. 1a is a schematic illustration of a synchronous drive apparatus for a DOHC motor vehicle internal combustion engine, incorporating a non-circular sprocket;

FIG. 1b is a schematic illustration of a synchronous drive apparatus for a SOHC motor vehicle internal combustion engine, incorporating a non-circular sprocket;

FIG. 2 is a magnified view of the non-circular sprocket shown in FIG. 1b;

FIG. 3 is a flow diagram illustrating a method of generating a non-round sprocket;

FIG. 4a is a schematic illustration of a non-circular sprocket component, which may be used for example in a motor vehicle internal combustion engine;

FIG. 4b is a schematic illustration of a non-circular polygon template used in a method for constructing a non-circular sprocket component;

FIGS. 5a and 5b illustrate the effect of torsional vibration on sprocket position and on belt tension for a round sprocket of the prior art;

FIGS. 6a-6c illustrate the effect of torsional vibration on sprocket position and on belt tension for a non-round sprocket;

FIGS. 7a-7c illustrate a method of determining positions of vertices to form the polygon shown in FIG. 2;

FIG. 8 is a schematic illustration of a non-round sprocket in a selected orientation and its engagement with a belt; and

FIG. 9 is a schematic illustration of a non-round sprocket in another selected orientation and its engagement with a belt.

### DETAILED DESCRIPTION

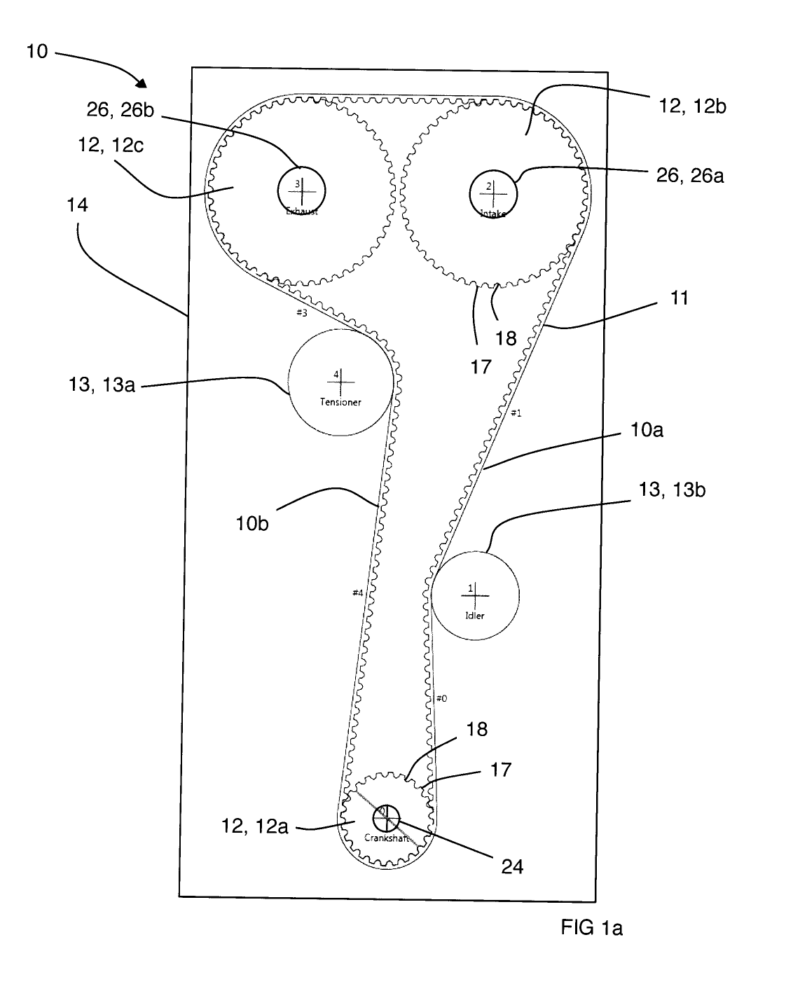

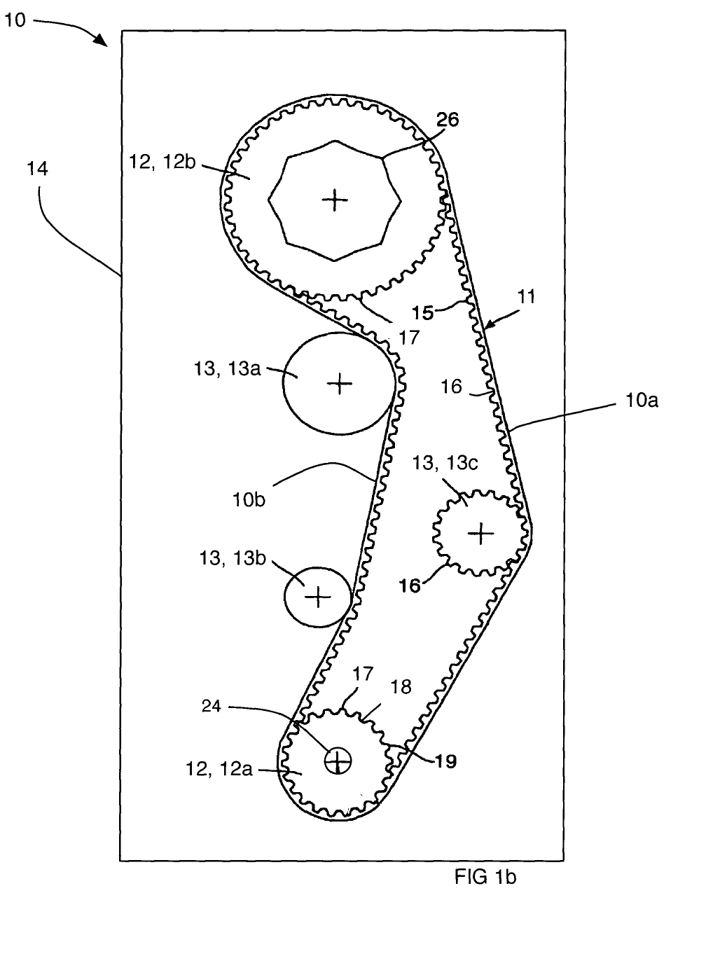

Reference is made to FIG. 1a, which is a diagrammatic representation of a synchronous drive system 10 for a vehicle internal combustion engine 14 (shown schematically as a rectangle) in accordance with an embodiment of the invention. The synchronous drive system 10 comprises an endless drive member 11 (which may be, for example, a timing belt), first, second and third rotary components 12 (shown individually at 12a, 12b and 12c), and additional rotary components 13 (shown individually at 13a and 13b). The rotary components 12 and 13 may also be referred to a rotors, or sprockets. However when the term sprocket is used, it will be understood that the rotary component 12 or 13 could be another type of rotary component instead. Throughout this disclosure the endless drive member 11 may be referred to as a belt or as a timing belt for readability, however it will be understood that other types of synchronous endless drive member could be used. The belt 11 has a plurality of teeth 15 separated from each other by intervening valleys 16. Each sprocket having a body 8 having a plurality of teeth 17 and intervening valleys 18, wherein the teeth 17 engage the valleys 16 of the belt 11. The rotors 12 may be referred to as sprockets herein for readability, however it will be understood that other types of rotor may be used depending on the type of endless drive member used. The rotor 13a is part of a belt tensioner and is urged against the non-toothed side of the belt 11 so as to tension the belt 11 in known manner. The rotor 13b is a fixed idler pulley that bears upon the non-toothed side of timing belt 11.

The sprocket 12a is coupled to the crankshaft (shown at 24) of the internal combustion engine, and the sprockets 12b and 12c are coupled to camshafts 26a and 26b (which control the operation of intake valves and exhaust valves respectively) for the internal combustion engine 14. While the engine 14 in this example is a DOHC design, it will be understood that any other suitable type of engine may be used, such as, for example, a SOHC design.

The timing belt 11 is engaged with the sprockets 12a, 12b and 12c, such that the crankshaft sprocket 12a drives the belt 11 and the camshaft sprockets 12b and 12c are driven by the belt 11.

A similar arrangement is shown in FIG. 1b, except that there is only one camshaft 26 (the engine 14 is a SOHC design), and consequently there is only one camshaft sprocket 12. The engine 14 shown in FIG. 1b also has a third additional rotor 13c, which may be driven by the belt 11 to drive an accessory such as a water pump.

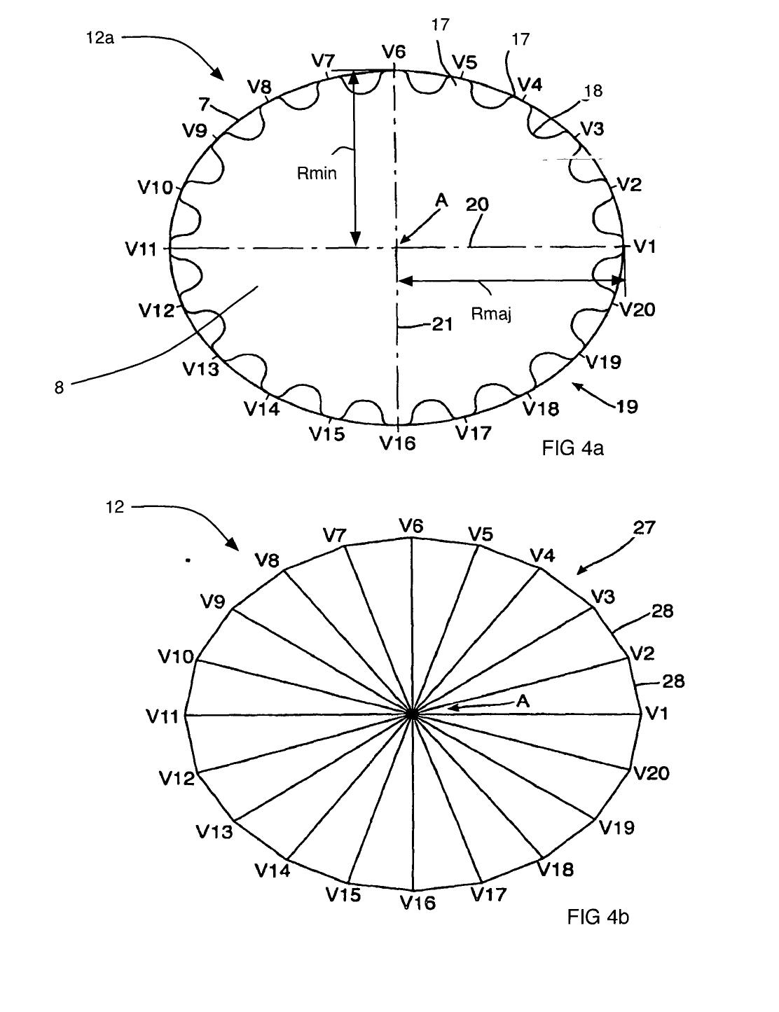

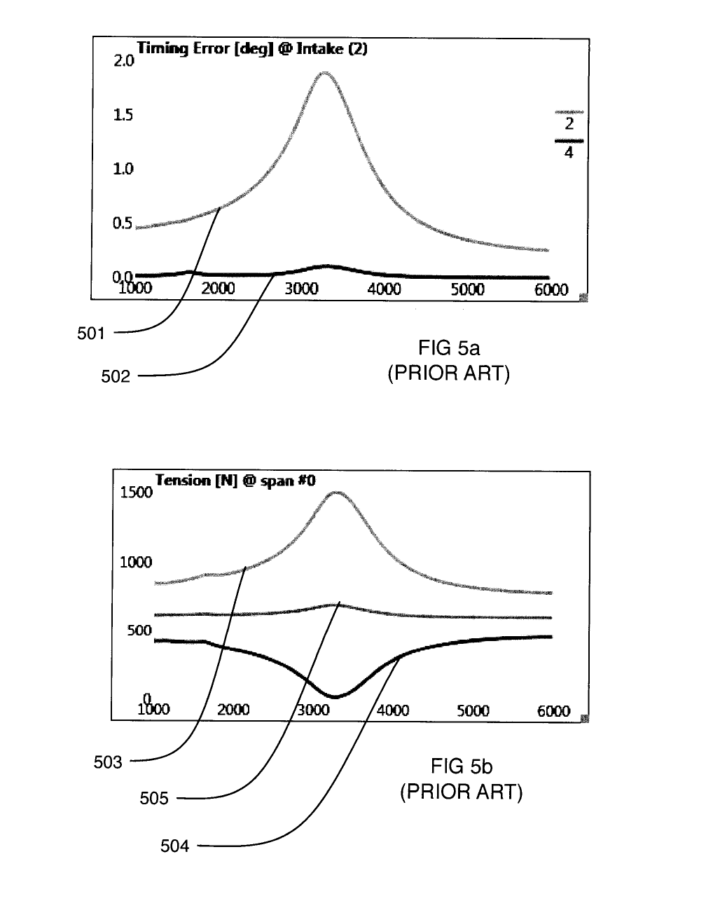

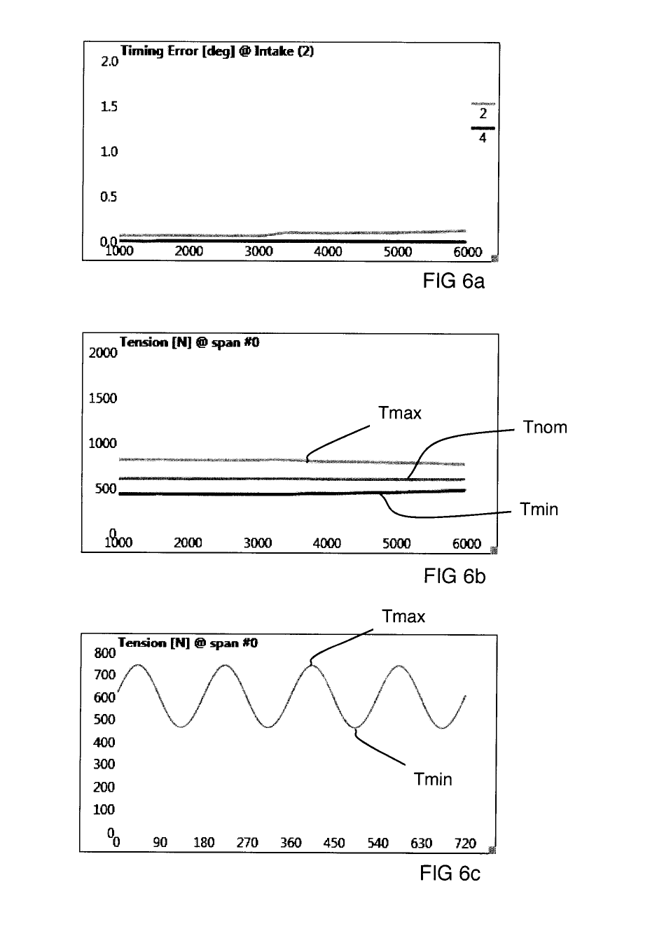

Torsional vibrations can occur at the crankshaft 24 as a result of the reciprocating movement of the engine pistons (not shown), and at the camshaft 26 as a result of the opening and closing of the intake and exhaust valves (not shown) by the cams (not shown) on the camshaft. To reduce the torsional vibrations, one or both of the crankshaft sprocket 12a and the camshaft sprocket 12b may be provided with a non-round profile. The non-round profile of the crankshaft sprocket 12a (shown greatly exaggerated at 19 in FIG. 2) is selected to modify the tension in the belt 11, which, in turn, changes the torque applied by the belt 11 to the camshaft sprocket 12b to be generally equal and opposite to the torque applied to the sprocket 12b during torsional vibrations. In this way, the torsional vibrations at the sprocket 12b can be reduced or even eliminated. The result of the non-round profile is that the tension in the belt 11 may cycle sinusoidally between generally constant upper and lower values as shown in FIG. 6c (whereas with a typical sprocket having a round profile the tension in the belt 11 may cycle with less consistency and over a larger range of tensions (shown in FIG. 5b) due to the torsional vibrations and the resonance that results therefrom. The profile 19 is also shown in FIG. 4a. The profile 19 may be generally elliptical and may thus have a major axis 20 and an associated major radius Rmaj and a minor axis 21 and an associated minor radius Rmin. In FIG. 4a, A represents the center of rotation of the sprocket 12.

The amount of tension in the belt 11 results in a proportionate amount of elongation in the belt 11. Thus for higher tensions the belt 11 stretches more, and for lower tensions the belt stretches less. It will be noted that the tensions will be different in the belt spans shown at 10a and 10b which are immediately upstream and downstream respectively from the crankshaft sprocket 12a. The belt span 10a extends between the crankshaft sprocket 12a and the intake valve camshaft sprocket 12b. The belt span 10b extends between the crankshaft sprocket 12a and the exhaust valve camshaft sprocket 12c. Assuming that the rotation of the crankshaft sprocket 12a is clockwise in the view shown in FIG. 1b, the belt span 10a may be on the ‘tight’ side of the crankshaft sprocket 12a and the belt span 10b may be on the ‘slack’ side of the crankshaft sprocket 12a. In other words, the belt span 10a will have higher tension than belt span 10b because belt span 10a is being pulled by the sprocket 12a. This discussion will focus on the belt span 10a.

The width of a belt tooth (shown at Wbt in FIG. 2) varies with the belt tension, as does the tooth pitch (shown at Pb). The non-round profile 19 of the sprocket 12a can include varying the sizes of the valleys 18 so that they are synchronized with the belt tension so that, at higher belt tensions the valleys 18 are wider, and at lower tensions the valleys 18 are less wide. The sprocket valley width is shown at Wsv in FIG. 2. By widening the sprocket valleys 18 and increasing the tooth pitch (shown at Ps) of the sprocket 12a at higher belt tensions, the valleys 18 can better accommodate the widened belt teeth 16 as the teeth 16 mesh with the sprocket valleys 18. This, in turn, can reduce stresses that could otherwise result if belt teeth 15 that are wider than nominal mesh with sprocket valleys 18 that are sized for belt teeth 15 having a nominal width, as could occur with a belt engaging a sprocket that has a constant tooth pitch and a constant valley width.

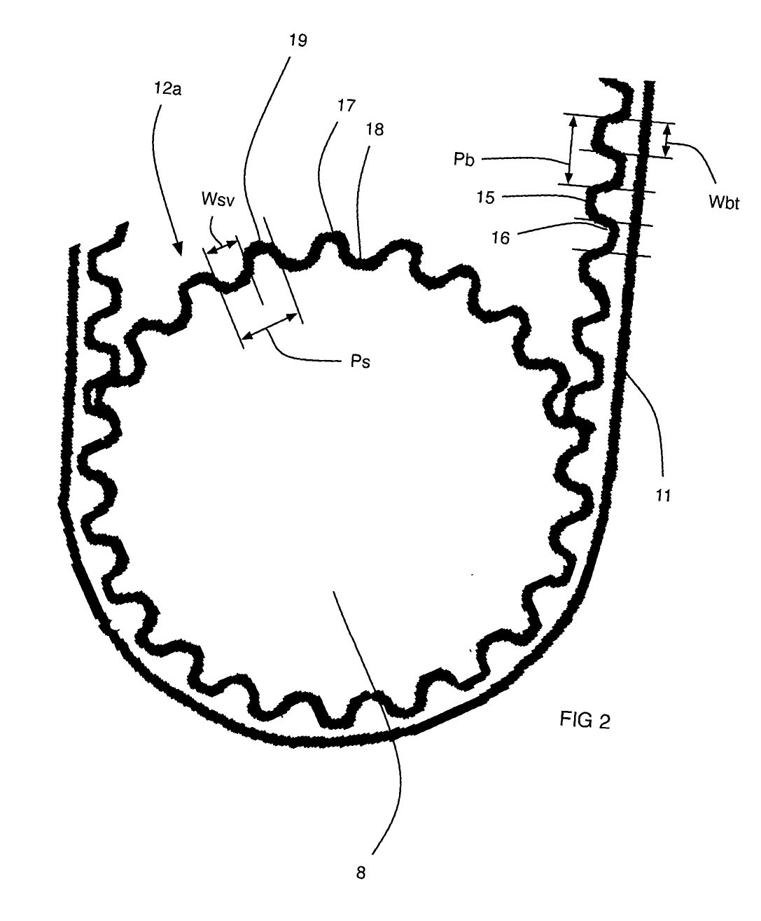

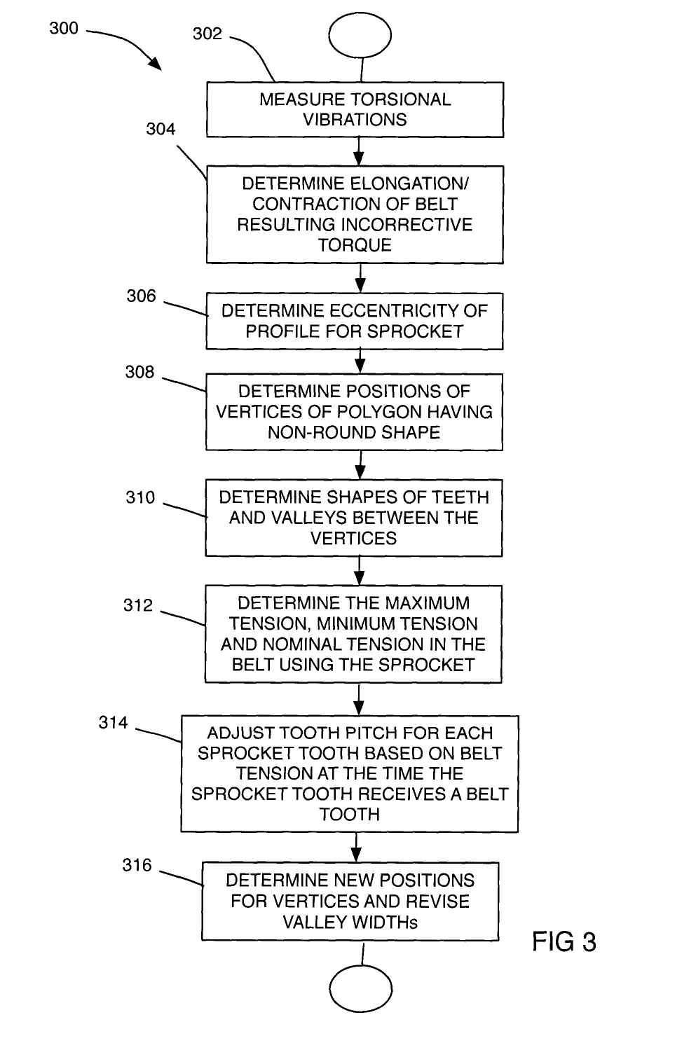

The profile of the sprocket 12a may be generated according to the principals described below and with reference to the method shown at 300 in FIG. 3 and with reference to the sprocket 12a as shown in FIG. 4a. In an initial step the positions of the centre points of the crowns of the teeth 17 (FIG. 4a) are determined. The crowns of the teeth 17 are shown at 9. To carry out this step, the torsional vibrations (which may be referred to as torsionals) for the engine are measured on a test apparatus using a round sprocket of a given diameter on the crankshaft, at step 302. The torsionals are, in effect, a fluctuating torque applied to the camshaft or camshafts of an engine (and therefore to the camshaft sprocket or sprockets). The torsionals result in a fluctuating timing error in a camshaft (i.e. a fluctuating difference between the actual rotational position of a camshaft relative to its expected rotational position if it were moving at constant speed), and also result in fluctuations in belt tension. The amplitude of the timing error fluctuation for an example engine is shown in FIG. 5a in relation to engine RPM. Two curves are shown: curve 501 shows the amplitude of the timing error fluctuations resulting from second order vibrations, and curve 502 shows the amplitude of the timing error fluctuations resulting from fourth order vibrations. FIG. 5b shows the amplitude of belt tension fluctuation in relation to engine RPM as a result of the torsionals. Curve 503 shows the amplitude of belt tension fluctuation arising from second order vibrations, and curve 504 shows the amplitude of belt tension fluctuation arising from fourth order vibrations. Curve 505 is the resulting average amplitude of belt tension fluctuation between the two curves 503 and 504. In order to reduce the torsionals a corrective torque can be applied to a camshaft that is generally equal and opposite to the torque applied to the camshaft from the torsionals. This torque can be applied by use of a non-round crankshaft sprocket 12a. The non-round shape of the sprocket 12a impacts the torque applied by the sprocket 12a to the belt 11 and therefore impacts the belt tension. The belt tension impacts the torque applied by the belt 11 on the camshaft sprockets 12b and 12c and therefore on the camshaft 26. Thus by controlling the belt tension one can apply a corrective torque to the camshafts 26 to counteract the torques incurred from the cams and valves. As will be understood, the torque applied by the belt 11 to a camshaft is related to the belt tension and the radius of the camshaft sprocket 12.

Additionally, it will be understood that the belt 11 may operate like a simple elastic element, in that the belt tension in belt span 10a may be directly related to the belt length of span 10a (assuming that the belt tension is within the elastic range of the belt 11), based on a stiffness coefficient for the belt, which may be likened to a spring constant for the belt, which is represented by ‘k’. A relationship can be formulated as follows between the amplitude of the periodic elongation and contraction of the belt span 10a (represented by ‘B’) and the associated corrective torque that is exerted at the camshaft (represented by ‘T’):

B=T/(rk)

Where r is the effective radius of the sprocket 26 through which torque is transferred from the belt 11. In a synchronous belt drive, torque is transferred between the crowns 9 of the teeth on the sprocket 12A and the valleys 16 on the belt. Accordingly, the effective radius r would be the radius from the centre of rotation of the sprocket 12b to the crowns 9 of the teeth 17 on the sprocket 12b.

The value of k, the spring constant for the belt 11, may be determined using a tension test. As is known for springs, f=kx, where f is a force or a change in force being applied to the spring, k is the spring constant, and x is a change in length of the spring. Accordingly, to determine k for the belt 11, a test can be carried out to determine the force or the change in force that is needed to achieve a certain change in length in the belt 11, optionally using a belt span of the same length as belt span 10a. Once f and x are known, k can be determined as k=f/x.

Once the desired amplitude of the periodic elongation and contraction of the belt span 10a is determined, at step 304 (i.e. once B is determined), it is possible to determine the amount of offset that is present between Rmaj of the elliptical profile 19 and a reference circle having a radius that is midway between Rmaj and Rmin, which may be referred to as the eccentricity and given the symbol E. It has been determined that the relationship between the eccentricity E and the value of B is: E=2B. Determining E is step 306.

For example, if it is determined that the value of B for a given belt 11 and engine is 0.5 mm, then the eccentricity of the sprocket 12a is 1 mm.

Using the eccentricity, the value for Rmaj of the sprocket can be determined. The centre point of the crown 9 of the first tooth 17 of the profile 19 is shown in FIG. 4a at V1, and is the point along the major axis 20 having a value of Rmaj. For greater certainty it will be understood that the origin of the major and minor axes is the point A, (i.e. the center of rotation of the sprocket 12a). From this first point V1, it is possible to determine the center points V2-V20 of the crowns 9 of all the other teeth 17 on the sprocket 12a, thereby forming a generally elliptical polygon shown at 27 in FIG. 4b, having sides 28, and vertices Vn (in the example shown there are 20 vertices which are numbered V1-V20), wherein the lengths of the sides 28 correspond to the tooth pitch of the sprocket 12a. It has been determined that the position of a subsequent vertex when the position of first vertex can be based on the following formula:

$$Rn = E + B cos ( 2 \cdot π \cdot \frac{( n - 1 )}{N} \cdot M )$$

where:
Rn=the distance from a vertex Vn to the center of rotation A
n=the number of the particular vertex whose position is being determined
E=the radius of the original circle from which the elliptical profile is being generated
B=the eccentricity, as determined above
N=the total number of teeth on the sprocket
M=the number of regions of the profile 19 that extend outwardly beyond the radius of the original circle (which may be referred to as ‘poles’). For an elliptical shape the number of ‘poles’ is 2; for a generally triangular shape the number of poles is 3; for a square shape the number of poles is 4, and so on. The present disclosure has described a profile having 2 poles (i.e. an elliptical profile), however it is possible to provide the profile 19 with additional poles in order to assist in cancelling higher order torsional vibrations from the camshaft 26. This is described in U.S. Pat. No. 8,042,507, the contents of which are incorporated herein in their entirety.

The term

$$2 \cdot π \cdot \frac{( n - 1 )}{N} \cdot M$$

is a value that is a first approximation of the angle of a given vertex Vn relative to the major axis 20, (specifically relative to the portion of the major axis 20 that passes through the final vertex (in this case V20). This approximation is represented by θn(approx), and the true angle is represented by θn(true), where n is the number of the particular vertex whose position is being determined. Because the value of this term is initially an approximation, the resulting radius Rn is likewise an approximation of the true radius Rn. The resulting radius from the formula may thus be referred to as Rn(approx) and the true radius may be referred to as Rn(true). Thus, this formula has two unknown values, namely the true angle θn(true) and the true radius Rn(true). To find the values for Rn(true) and θn(true) to substantially any desired level of accuracy, the formula above may be iterated using any suitable computer. Once the radius Rn(true) and the angle θn(true) have been determined the position of the vertex Vn can be determined using basic polar geometry.

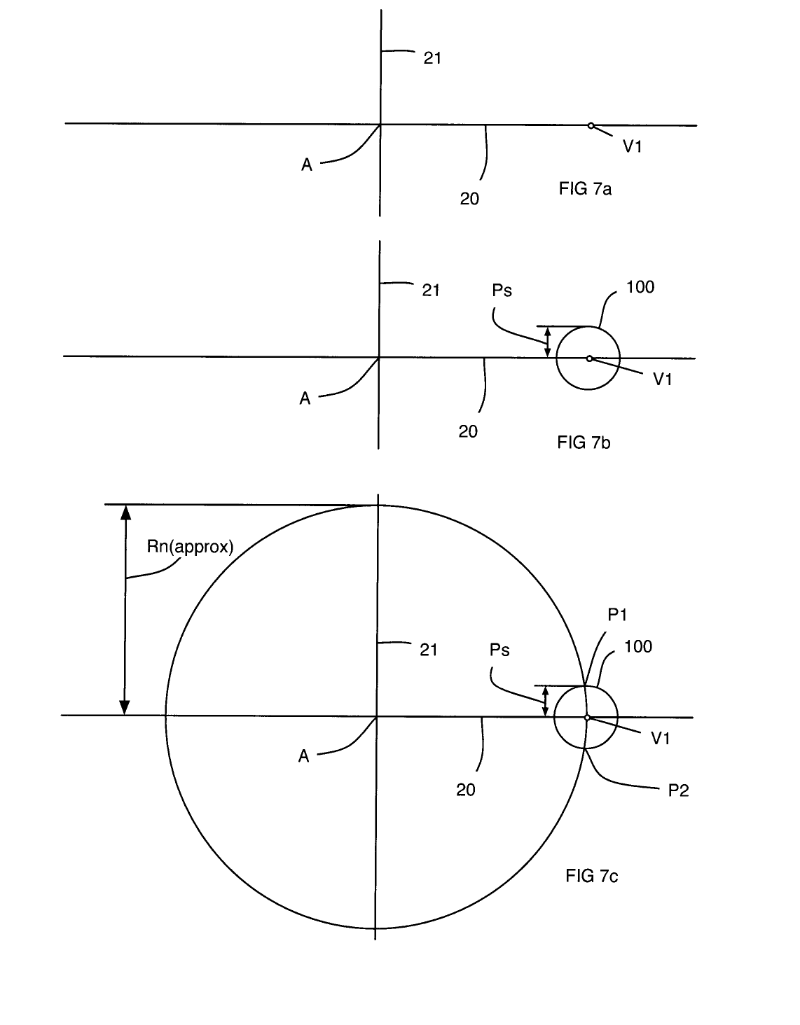

Without iterating the formula however, the position of the vertex Vn can be determined to a potentially suitable degree of accuracy using an alternative technique that may be less computationally intensive than the one above, with reference to FIGS. 7a-7d. FIG. 7a shows the vertex V1 on the major axis 20. The sprocket tooth pitch Ps is initially held as a constant value along the entire periphery of the sprocket 12a (although adjustments to the tooth pitch Ps are described below in a later step in the method of designing the sprocket 12a). Thus, the position of the vertex V2 must lie (at this stage of the sprocket design) at some point along a circle centered on vertex V1, and having a radius that is the tooth pitch Ps. The aforementioned statement may be referred to as condition 1. FIG. 7b shows the circle having radius Ps at 100.

Additionally, the formula above is applied, resulting in a value for radius Rn(approx). A circle 102 having a radius of Rn(approx) that results from the formula is shown in FIG. 7c. The position of vertex V2 will lie approximately on this circle 102. This may be referred to as condition 2.

The two points at which the circles 100 and 102 intersect are shown at P1 and P2 and represent the two possible positions for V2 that satisfy both conditions above. Assuming that Rn(approx) is close to the true radius Rn(true), one of the two intersection points P1 and P2 may be used as the position of the first vertex V2. Given that the vertices Vn progress around the profile 19 in a counterclockwise direction in FIG. 4b the intersection point P1 may be used as the position of V2. Once the position of V1 is established, the steps illustrated in FIGS. 7a-7c may be repeated to determine the position of vertices V2-V19. The position of vertex V1 is, as noted above, already known as it is on the major axis at a distance of Rmaj from the origin A. This method of determining the positions of V1-V20 has been tested and compares closely to the positions for V1-V20 determined using the iterative process described above. While this method has been shown graphically in FIGS. 7a-7c, it will be understood that suitable trigonometric equations could be used to determine the intersection points P1 and/or P2, thereby making the method more suitable for implementation by computer. It will further be noted that, while the value of Rn(approx) has been used in the method described above, the formula above could be iteratively repeated so as to refine the value of Rn(approx) until it approaches Rn(true) to whatever level of accuracy is desired, at which point that refined value may be used to carry out the method of finding the intersection points P1 and/or P2. Determining the positions of the vertices V1-V20 is step 308 of the method 300 in FIG. 3.

In an example sprocket, some values may be as follows:

E=30.32 mm (average distance from an intersection Vn to the centre A)
B=1.2 mm (desired out-of-round factor)
N=20 (number of teeth required on the rotor)
M=2 (the number of protruding portions)
Using these values generates the following results:

### R1 31.52

### R2 31.29

### R3 30.69

### R4 29.95

### R5 29.35

### R6 29.12

### R7 29.35

### R8 29.95

### R9 30.69

### R10 31.29

### R11 31.52

### R12 31.29

### R13 30.69

### R14 29.95

### R15 29.35

### R16 29.12

### R17 29.35

### R18 29.95

### R19 30.69

### R20 31.29

Once the vertices V1-V20 have been established, the shapes of the teeth 17 and valleys 18 are determined at step 310 in FIG. 3. Referring to FIGS. 4a and 4b, a selected tooth/valley profile is inserted between each pair of vertices, (i.e. between vertices V1 and V2, between V2 and V3, and so on). It will be recognized the aforementioned tooth/valley profile is made up of a valley 18, surrounded on each side by a half-tooth, which ends at a vertex Vn. The profile of the valley 18 between each pair of adjacent half-teeth is substantially the same. The profile of the crowns 9 of the teeth 17 at least initially is formed by the joining of two half-teeth at each vertex Vn. The profile of the crowns 9 may be adjusted from there in any suitable way, such as, for example, in any manner described in U.S. Pat. No. 8,042,507.

The sprocket 12a generated by the above method may be used in a test assembly configured to represent the actual engine during use, to determine the actual fluctuations in belt tension (at step 312) that occur with that sprocket. The belt tension may be measured using any suitable belt tension procedure and apparatus. The belt tension fluctuations may be measured at different engine speeds, such as, for example, when the engine is idling and also when the engine is at a typical RPM that would represent the vehicle traveling at a selected cruising speed such as 100 kph. As explained in U.S. Pat. No. 8,042,507 and in U.S. Pat. No. 7,232,391 (which is incorporated herein in its entirety), the belt tension using the sprocket 12a as configured thus far, will vary within upper and lower limits as shown in FIG. 6c, and will be synchronized to the rotation of the sprocket 12a.

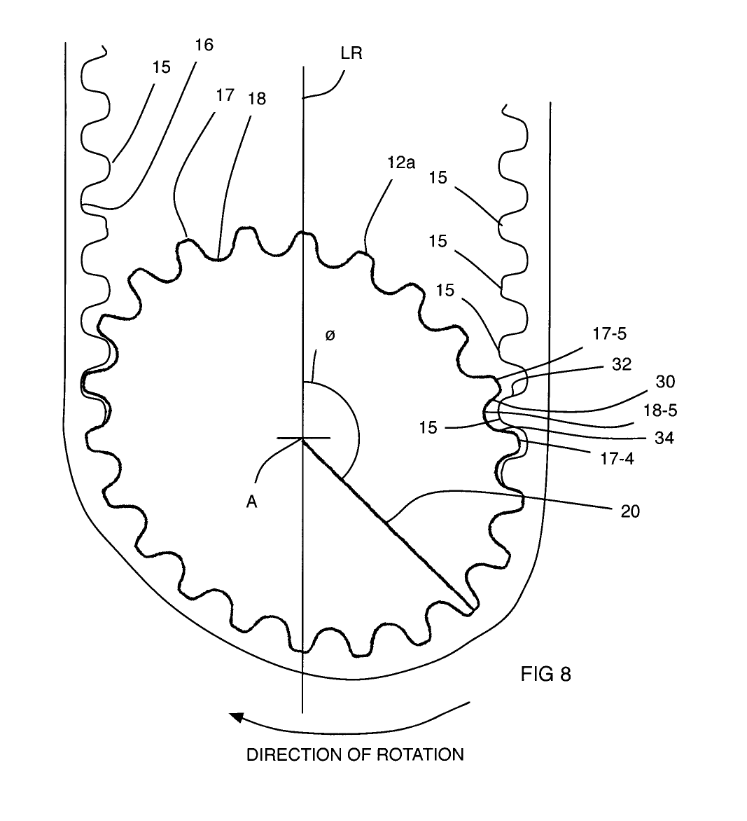

As the belt's tension increases and decreases, the belt 11 will stretch and contract by some amount, based on its stiffness value (i.e. its spring constant k). As a result, the tooth pitch Pb of the belt 11 will vary by some amount based on the belt tension at any given instant. Because the belt tension is predictable and is synchronized to the rotation of the sprocket 12a, the tooth pitch Ps of the sprocket 12a and in particular the valley width of the sprocket 12a for each tooth 17 and valley 18 can be adjusted based on the belt tension. More specifically, as the sprocket 12a causes the belt tension in the span 10a to increase, the tooth pitch Ps and the valley width may be adjusted so as to better accommodate the increased tooth pitch Pb, and increased tooth width of the teeth 15 of the belt 11. In an example shown in FIG. 8, the belt tension may be at its maximum when the sprocket 12a is oriented such that the major axis 20 is at an angle ø of about 135 degrees from the reference line LR that bisects the belt wrap on the sprocket 12a, as is described in U.S. Pat. No. 7,232,391. Thus when the sprocket 12a is in this orientation, the belt 11 is at maximum stretch and accordingly, the belt pitch Pb is at its greatest and the belt teeth 15 are at their maximum width. By adjusting (in this case, increasing) the tooth pitch Ps of the sprocket 12a between tooth 17-3 and tooth 17-4, and by adjusting (i.e. increasing) the valley width of valley 18-4 that sits between these teeth, the sprocket valley 18-4 is better positioned to receive the belt tooth 15. Increasing the tooth pitch Ps adjusts the position of the leading edge (shown at 30) of the tooth 17-4 so that the leading edge 30 is more likely to align with the trailing edge (shown at 32) of the belt tooth 15, and to not push unduly on the trailing edge 32. Moreover, by adjusting the valley width, the valley 18-4 is better able to accommodate the increased width of the belt tooth 15 that results form the increased belt tension at that instant. This also reduces the likelihood of the leading edge 30 of the sprocket tooth 17-4 or the trailing edge shown at 34 of the sprocket tooth 17-3 pushing unduly on the belt tooth 15 just entering the valley 18-4. As a result, the stresses on the belt tooth 15 are reduced as compared to the stresses that may be incurred cyclically on the belt tooth 15 if no adjustments were made to the valley width and the sprocket tooth pitch Ps.

Starting from the non-round sprocket 12a generated as described above, a formula that provides the adjustment to the sprocket tooth pitch Ps is:

### Where:

$$\partial = \frac{( Tn - T nom )}{k} \cdot Ps$$

δ=the amount of adjustment to make to the tooth pitch Ps
Tn=the tension in the belt as a particular valley n is about to receive a belt tooth
Tnom=the nominal tension in the belt and shown as Tnom in FIG. 6b (i.e. the average between the maximum tension (shown at Tmax in FIGS. 6b and 6c) and the minimum tension (shown at Tmin))
k=the belt stiffness (i.e. the spring constant for the belt)

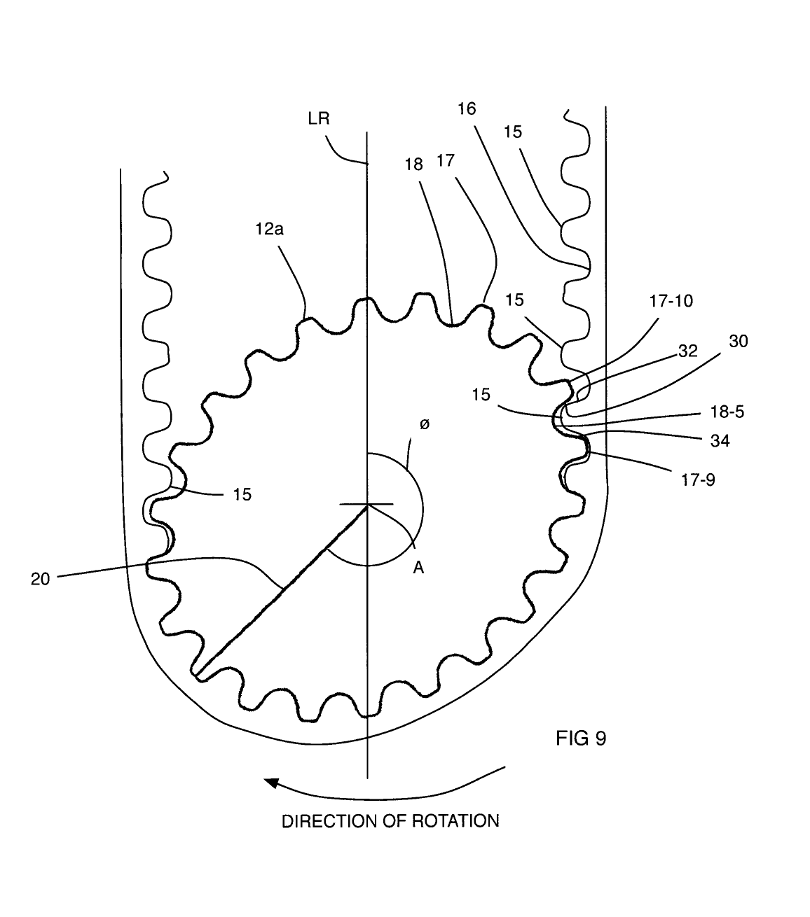

Thus when the tension is at the maximum (i.e. when the sprocket 12a is at 135 degrees relative to reference line LR such that the valley 18-4 is receiving a belt tooth 15), the tooth pitch Ps between teeth 17-3 and 17-4 is adjusted to be at a maximum (i.e. Ps+δ at maximum belt tension). Conversely, when the sprocket 12a is at 225 degrees relative to reference link LR as shown in FIG. 9 the belt tension will be at a minimum, in which case, the sprocket tooth pitch Ps will be adjusted downward to a minimum from the tooth pitch used in the non-adjusted sprocket 12a (i.e. Ps+δ at minimum belt tension (wherein a will be negative since the belt tension Tn will be below Tnom)). The belt tension at the rest of the orientations of the sprocket 12a will be somewhere between the maximum and minimum tensions, and the tooth pitch Ps will be adjusted accordingly. As can be seen from the description above, the sprocket valley 18 having the maximum width is the valley 18 that is approximately 45 degrees behind the major axis 20 (in the direction of rotation, which is shown in FIGS. 8 and 9). Similarly, the sprocket valley 18 having the minimum width is the valley 18 that is approximately 45 degrees ahead of the major axis 20 in the direction of rotation. Given that the tension as shown in FIG. 6c varies sinusoidally between the maximum and minimum values Tmax and Tmin, the sprocket valley width preferably varies generally sinusoidally between the maximum and minimum widths. Similarly, in a preferred embodiment, the tooth pitch Ps varies generally sinusoidally reaching a maximum about 45 degrees behind the major axis, and reaching a minimum about 45 degrees ahead of the major axis. Thus, there are two maximums and two minimums for the tooth pitch Ps and the valley width about the 360 degree periphery of the sprocket 12a.

The adjustment made to the valley width at any depth of the valley 18 will be in the same proportion as the change in the tooth pitch. Thus, if the tooth pitch changed by 0.1%, the width at each depth in the valley 18 will change by 0.1%. The adjustment to the tooth pitch is step 314 in FIG. 3.

Upon determining the amount of adjustment to make to the sprocket tooth pitch Ps, the new position for the subsequent vertex may be found by reverting back to the method shown in FIGS. 7a-7c, wherein the original circle 100 is replaced by a new circle 100 having a radius equal to the modified tooth pitch. Alternatively any other suitable way of determining the new position of the subsequent vertex may be used. The determining of the new positions of the vertices is step 316 in FIG. 3. The adjustment to the valley widths once the new positions of the vertices are established may also be carried out in step 316.

It will be understood that the steps of the method 300 may be carried out in a different order to some extent.

A variety of other alterations and modifications may be made to the embodiments described herein without departing from the fair meaning of the accompanying claims.

1. A non-circular rotary component, comprising:
a body that has a non-circular periphery; and
a plurality of rotary component teeth positioned about the periphery of the body, wherein the non-circular periphery of the body causes variation in the tension generated in an endless drive member engaged with the rotary component during rotation of the rotary component about an axis, wherein a valley separates each rotary component tooth from each adjacent rotary component tooth, wherein each valley has a width and each pair of adjacent rotary component teeth have an associated tooth pitch,
wherein at least one property selected from the group of properties consisting of: the width of each valley and the tooth pitch between each pair of adjacent rotary component teeth is generally related to the amount of tension generated in the endless drive member during rotation of the rotary component about the axis at a time when the valley receives a tooth on the endless drive member.

2. A rotary component as claimed in claim 1, wherein the valleys have widths that change generally according to a sinusoidal pattern.

3. A rotary component as claimed in claim 1, wherein the rotary component has a generally elliptical shape, having a major axis and a minor axis, wherein the widths of the valleys vary between a maximum width and a minimum width and wherein the valleys that have the maximum width are about 45 degrees behind the major axis in a direction of rotation of the rotary component.

4. A rotary component as claimed in claim 3, wherein the valleys that have the minimum width are about 45 degrees ahead the major axis in a direction of rotation of the rotary component.

5. A rotary component as claimed in claim 1, wherein the rotary component is a sprocket.

6. A rotary component as claimed in claim 1, wherein both the width of each valley and the tooth pitch between each pair of adjacent rotary component teeth are generally related to the amount of tension generated in the endless drive member during rotation of the rotary component about the axis at a time when the valley receives a tooth on the endless drive member.
